(19) United States
(12) Patent Application Publication
(10) Pub. No.: US 2010/0243405 A1
(43) Pub. Date: Sep. 30, 2010

(54) WASTE COLLECTION SYSTEM AND METHOD FOR OPENING/CLOSING WASTE RECEIVING DEVICE IN THE WASTE COLLECTION SYSTEM

(75) Inventors: Seung-Hyun KANG, Yongin-si (KR); Jong-Kyu HWANG, Anyang-si (KR); Yun-Ho JUNG, Suwon-si (KR); Sang-Bong CHANG, Seoul (KR)

Correspondence Address: LAW OFFICES OF ALBERT WAI-KIT CHAN, PLLC, 141-07 20TH AVENUE, WORLD PLAZA, SUITE 604, WHITESTONE, NY, 11357, US

(73) Assignees: KOLON CONSTRUCTION CO., LTD., Gwachun-si (KR); EUNSUNG PLANT CO., LTD., Siheung-si (KR)

(21) Appl. No.: 12/562,637

(22) Filed: Sep. 18, 2009

(30) Foreign Application Priority Data
Mar. 24, 2009 (KR) 10-2009-0025016

(51) Int. Cl. B65F 5/00; B65G 11/20; E05F 11/12

(52) U.S. Cl. 193/32; 49/344

(57) ABSTRACT

There are provided a waste collection system and a method for opening/closing a waste receiving device in the waste collecting system. The waste collection system comprises: a cover formed to be opened/closed on a waste receiving device; a damper formed to be opened/closed under the waste receiving device through the cover and an interlocker; and a housing. The waste collection system further comprises: a user recognition system positioned at the front of the housing; and a driving unit for driving the opening/closing of the damper, wherein the driving unit is on/off based on the results of the user recognition system.

In the waste collection system which comprises: a cover formed to be opened/closed on a waste receiving device; a damper formed to be opened/closed under the waste receiving device through the cover and an interlocker; and a housing, wherein a user recognition system is operatively installed at the front of the housing, the method for automatically opening/closing the waste receiving device comprises: the steps of: bringing a user recognition card into contact with the user recognition system; decoding information stored in the user recognition card; and opening the waste receiving device by driving the interlocker if a user is one having access to the waste collection system as a result of decoding the information.

### CROSS-REFERENCE TO RELATED APPLICATION

This application claims the benefit of Korean Patent Application No. 2009-0025016, filed Mar. 24, 2009, the disclosure of which is hereby incorporated herein by reference in its entirety.

### BACKGROUND OF THE INVENTION

1. Field of the Invention

The present invention relates to a waste collection system including an capacity-limited waste receiving device, and more particularly, to a waste collection system in which a waste receiving device in a vacuum-conveyance waste collection system (which conveys waste along a pipeline) is improved to be more efficient, and a method for opening/closing the waste receiving device in the waste collection system.

2. Description of the Related Art

According to a conventional method of collecting waste generated by each household living in condominiums, apartments and public houses, when people drop off the waste at a certain place, a waste collection vehicle picks up the waste. However, in the conventional method, since the waste is abandoned in a waste collecting place installed in a multi-unit building area for a certain period, it is unpleasant to see, it smells bad especially in the summer time and it becomes a habitat and hiding place for flies and mosquitoes.

Therefore, an automatic system for collecting waste has been introduced. When the waste is put into a waste receiving device positioned at a certain place, the waste is conveyed to and collected at a central waste collecting station through a conveying line buried underground, based on the control of a computer automatic control system.

According to the system of automatically collecting waste, each fixed collecting facility automatically conveys the waste to a central collecting station. The waste received through a waste receiving device is temporarily to stored in a chute under which a discharge valve is installed, and when an air blower installed within the central collecting station is operated, an air inlet is opened so that air is drawn into the conveying line buried underground. Then, when a strong air flow is formed in the conveying line, the discharge valve positioned under the chute is open and the waste stored within the chute moves down into the conveying line buried underground by gravity and air suction power, to be conveyed to the central collecting station, together with the high-speed air. In this system, when the waste is put into the waste receiving device, the waste is automatically conveyed. Therefore, since the waste does not need to accumulate at a certain place, the surrounding environment is pleasant and nice in appearance and mice, cats and noxious insects are absent, thereby forming a clean residential environment.

However, in the aforementioned system, a user opens a cover to open a conventional waste receiving device. Therefore, when the user holds a heavy garbage bag or holds garbage bags in both hands, it is inconvenient to use the system. Moreover, the conventional waste receiving device does not limit various oversized waste (such as bulky waste, a long rod or the like) from being received into the waste collection system. Therefore, when the waste receiving device or the discharge valve is blocked, the operation of the system has to be stopped and the device or discharge valve needs to be fixed. Furthermore, since waste cannot be put into the waste receiving device until the device or the discharge valve is fixed, this system would frequently have more problems than the method of collecting waste by garbage collectors.

Moreover, in a community waste collection system which is installed in the multi-unit building area, such as condominiums or row houses, since even those who do not have access to the community waste collection system use it without permission, the waste collection system would malfunction.

### SUMMARY OF THE INVENTION

Therefore, it is an aspect of the present invention to provide a waste collection system with a capacity-limited waste receiving device which is improved and more efficient than a waste receiving device in a vacuum-conveyance waste collection system (which conveys waste along a line), making it easier for a user to put waste into the waste receiving device, preventing any oversized waste from being put into the waste receiving device, and allowing only those having access to the waste collection system to use it.

The above and other aspects of the present invention are substantially realized by providing a waste collection system, comprising: a cover formed to be opened/closed on a waste receiving device; a damper formed to be opened/closed under the waste receiving device through the cover and an interlocker; and a housing. The waste collection system further comprises: a user recognition system positioned at the front of the housing; and a driving unit for driving the opening/closing of the damper, wherein the driving unit is turned on/off, based on the results of the user recognition system.

In accordance with another aspect of the present invention, there is provide a method for automatically opening/closing a waste receiving device in a waste collection system which comprises: a cover formed to be opened/closed on the waste receiving device; a damper formed to be opened/closed under the waste receiving device through the cover and an interlocker; and a housing, wherein a user recognition system is operatively installed at the front of the housing, the method comprising the steps of: bringing a user recognition card into contact with the user recognition system; decoding information stored in the user recognition card; and opening the waste receiving device by driving the interlocker if a user is one having access to the waste collection system as a result of decoding the information.

As described above, in the capacity-limited waste receiving device in the waste collection system (system for conveying waste through a line) according to the present invention, the cover and the damper, respectively installed on and under the inlet passage casing formed of a capacity-limited space, are operatively connected to prevent the oversized waste (i.e., waste being larger than a certain size, a rod being longer than a certain length, or the like) from being put into the waste receiving device. Accordingly, the waste collection system is prevented from malfunctioning due to the oversized waste being placed in to the collection system.

Furthermore, in the case where the recognition system to open the waste receiving device by using a RFID (Radio-Frequency Identification) card or barcode mode is operatively installed at the front of the housing, when the RFID card or barcode is brought into contact with the recognition system, the control unit recognizes the signal of the RFID card or barcode card so that the waste receiving device connected to the control unit is opened. Therefore, it is more convenient to use the waste collection system, compared to the conventional system in which a user holds and opens the cover of the conventional waste receiving device. Furthermore, in the case where the user recognition system is operatively installed at the front of the housing, since only those that have access to the waste collection system can use it, it is possible to prevent those that do not have access to it from dropping waste, without permission.

Furthermore, when the RFID card or the like is used, the cover of the waste receiving device is automatically closed after a certain time goes by since the cover is opened, thereby improving the convenience in use.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a capacity-limited waste receiving device being open when a cover is opened in a waste collection system according to the present invention;

FIG. 2 is a right sectional view illustrating the inside of the capacity-limited waste receiving device installed on and under the ground;

FIG. 3 is a left section view illustrating the inside of the capacity-limited waste receiving device installed on the ground;

FIG. 4 is a perspective view illustrating the capacity-limited waste receiving device in which the cover is closed and a damper is opened by an interlocker;

FIG. 5 is a block diagram illustrating a recognition system used in the waste collection system; and

FIG. 6 is a flow chart illustrating the control of automatically device/closing the cover of the capacity-limited waste receiving device in the waste collection system.

### DESCRIPTION OF REFERENCE NUMBERS OF MAJOR ELEMENTS

| | |
|---|---|
| 10: cover | 101: round bar |
| 20: housing | 21: inlet passage casing |
| 211: inlet guide | 22: under passage casing |
| 23: chute | 24: damper |
| 25: discharge valve | 26: interlocker |
| 261: first air cylinder | 262: damper shaft |
| 263: first link bar | 264: second link bar |
| 265: link tension bar | 266: gas spring |
| 267: cylinder arm | 268: cylinder bracket |
| 269: second air cylinder | 280: solenoid valve |
| 27: louver | 30: conveying-line |
| 31: compressed air pipe | 40: recognition system |
| 50: link cover | |

### DETAILED DESCRIPTION OF THE PREFERRED EMBODIMENT

The present invention will now be described more fully hereinafter to with reference to the accompanying drawings, in which preferred embodiments of the invention are shown. However, it is to be understood that the scope of the invention is not limited to the disclosed embodiments.

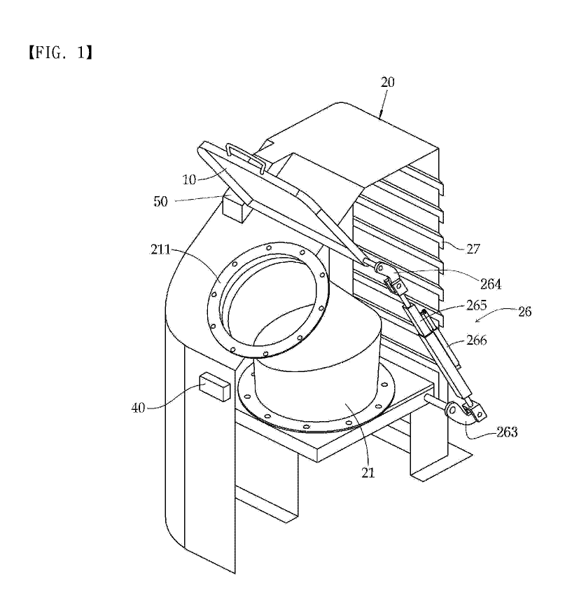

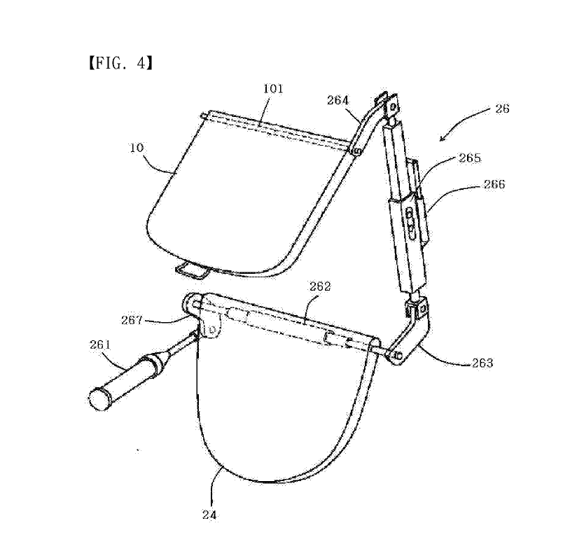

With reference to FIGS. 1 to 4, a capacity-limited waste receiving device according to an embodiment of the present invention will be described. The capacity-limited waste receiving device is applied to a waste collection system in which the waste being put through the waste receiving device is automatically conveyed to a central collecting station through a conveying line.

FIG. 1 is a perspective view illustrating the capacity-limited waste receiving device for the waste collection system according to the present invention, in which a cover is open. As illustrated in FIG. 1, the capacity-limited waste receiving device comprises: a cover 10 being opened/closed to open/close the waste receiving device; and a housing 20 with an upper end and a lower end, the upper end on which the cover 10 is installed and the lower end which it is connected to a conveying line 30 connected to the central collecting station. The housing 20 comprises: an inlet passage casing 21; an under passage casing 22; a damper 24; a chute 23; and an interlocker 26. The inlet passage casing 21 has an upper end to which the cover 10 is attached. The under passage casing 22 is installed under the inlet passage casing 21. The damper 24 is installed between the inlet passage casing 21 and the under passage casing 22. The chute 23 is connected to a lower end of the under passage casing 22. A discharge valve 25 to discharge waste to the conveying line 30 is installed under the chute 23. The interlocker 26 opens the cover 10 while closing the damper 24 or the interlocker 26 closes the cover 10 while opening the damper 24, so that the cover 10 and the damper 24 are operatively connected.

The interlocker 26 comprises: a damper shaft 262 fixedly connected to the damper 24 in a single body; a first air cylinder 261 connected to one end of the damper shaft 262, to drive the interlocker 26; a first link bar 263 connected to the other end of the damper shaft 262; a second link bar 264 connected to the cover 10, to open/close the cover 10; and a link tension bar 265 connected between the first link bar 263 and the second link bar 264. The interlocker 26 ensures that either the opening or the closing of the cover 10 is opposite to either the opening or closing of the damper 24. In other words, when the cover 10 is open the interlocker 26 ensures that the damper 24 is closed. In like manner, when the cover 10 is closed, the interlocker 26 ensures that the damper 24 is open.

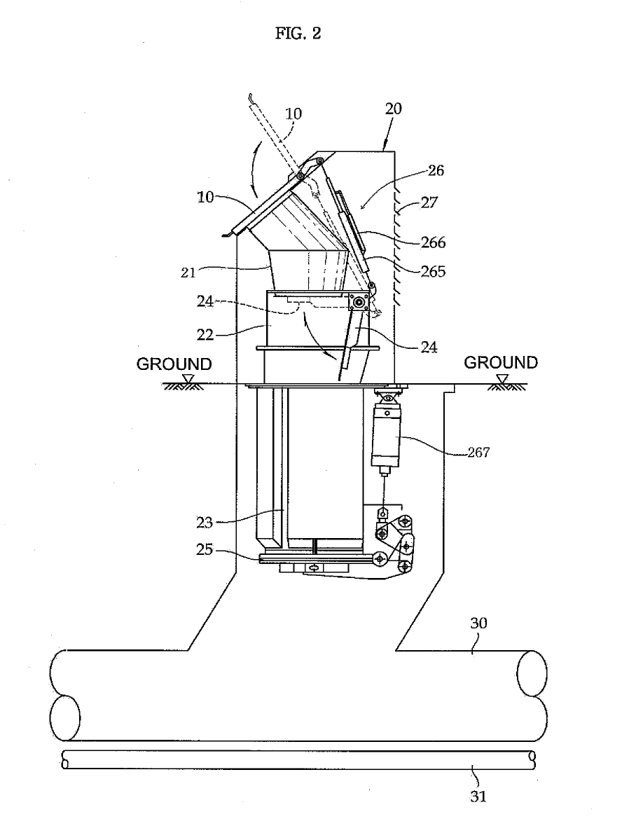

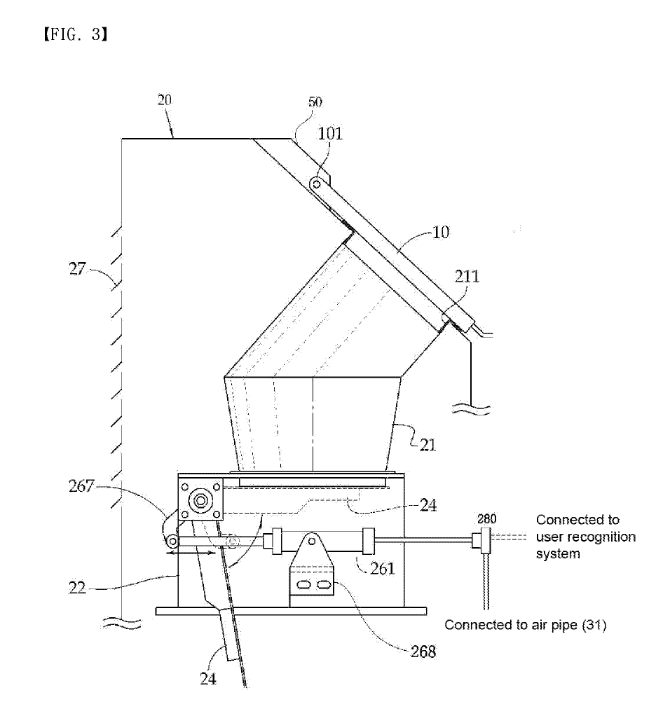

As illustrated in FIGS. 2 and 3, a louver 27 is installed at a back side of the housing 10, to draw external air into the housing 20. When the discharge valve 25 is opened, the louver 27 supplies the drawn air into the chute 23, thereby making it easy to discharge the waste stored in the chute 23 into the conveying line 30. Preferably, the louver 27 may be installed by using a coupling unit (screw or the like), to be separated from the housing 20 when the inside of the waste receiving device needs to be inspected.

An inlet guide 211 is further installed on the inlet passage casing 21. The inlet guide 211 maintains a vacant space at a certain distance from the inlet passage casing 21, to form a passage through which air flows into the inside of the inlet passage casing 21 from the outside of the inlet passage casing 21. A handle is fixedly connected to one side of the cover 10. The handle protrudes at a higher position than a lower end of the cover 10 and to be inclined upward at an angle. An air-filled packing is installed inside of a lower side of the cover 10, to maintain airtightness inside the waste receiving device and to perform an absorbing function to lessen noise and shock when the cover 10 is closed.

Link covers 50 are each installed at both sides on the housing 20. A round bar 101 is supported at a side of the link cover 50. The round bar 101 rotates around the central axis. The round bar 101 and the cover 10 are fixedly connected together in a single body.

The second link bar 264 is fixedly connected to one side of the round bar 101 in a single body. The cover 10 fixedly connected to the round bar 101 in the single body pivots up and down around the central axis of the round bar 101, thereby opening/closing the cover 10 installed above the inlet passage casing 21 of the waste receiving device.

The damper shaft 262 is installed at one side of an upper part of the under passage casing 22. The damper shaft 262 pivots around its central axis. The damper shaft 262 is fixedly connected to the damper 24 in a single body. The first air cylinder 261 is fixedly connected to one end of the damper shaft 262 by a cylinder arm 267. The first link bar 263 is fixedly connected to the other end of the damper shaft 262. The damper 24 fixedly connected to the damper shaft 262 in the single body pivots up and down around the central axis of the damper shaft 262, thereby opening/closing a lower opening of the inlet passage casing 21 of the waste receiving device.

As illustrated in FIG. 2, the first air cylinder 261 is driven by the air supplied from a compressed air pipe 31. A solenoid valve 28 is installed in the channel between the first air cylinder 216 and the compressed air pipe 31. The solenoid valve 280 to turn on/off a flow of a fluid by applying an electric current is driven by on/off signals from a user recognition system 40 operatively installed at the front of the housing 20.

As described above, the user recognition system 40 is electrically connected to the solenoid valve 28. The solenoid valve 280 is controlled to be on/off, based on the results of recognizing a user by the user recognition system 40, thereby opening/closing the waste receiving device.

The waste collection system according to the present invention uses the constitution in which the air cylinder is used as a unit to drive the interlocker 26. However, the present invention is not limited to the use of the air cylinder. The interlocker 26 may be driven by installing a motor under the interlocker 26 in the waste receiving device and forwardly or backwardly rotating the motor through a rack gear and a pinion gear.

The user recognition system 40 identifies whether a user is a registered user. When the user is a registered user, the cover 10 of the waste receiving device is operated to be automatically opened/closed. Simply, a RF mode or a barcode mode may be used as the user recognition system 40. However, the present invention is not limited to the use of the RF (Radio Frequency) mode or barcode mode. It is obvious to a person skilled in the art that different wireless communication technologies, such as Bluetooth, infrared-ray communication or the like, may be used.

In the waste collection system, for example, a RFID card is used as the user recognition system. In the case of authentication of a user using the RFID card, the RFID recognition system 40 largely comprises: a RFID card provided to a user and allowed to be used, and a RF receiving terminal formed proximate to the waste receiving device.

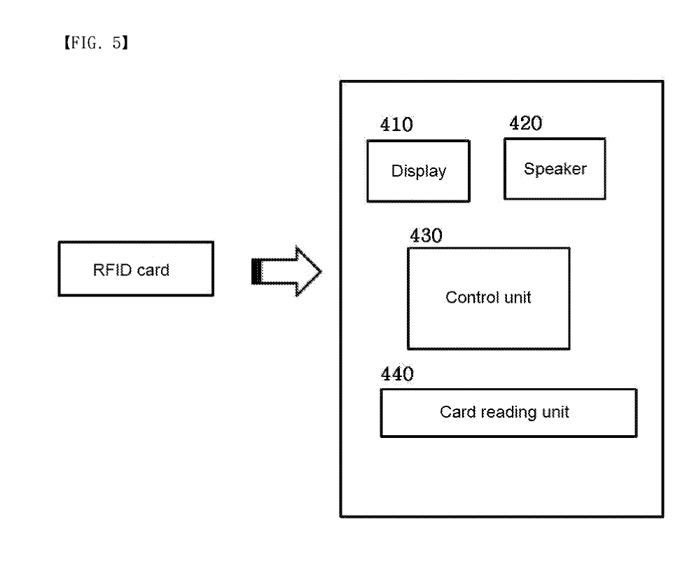

Further, as illustrated in FIG. 5, the RF receiving terminal comprises: a card reading unit 440 for reading information of the RFID card when it is in contact with the RFID card; a memory unit for storing IDs allowed to be used; a control unit 430 for controlling the RF receiving terminal and the on/off of the solenoid valve 280; and a display unit 410 for providing the results of reading the information to the user visually or a speaker unit 420 for providing the results of reading the information to the user auditorily. The RF receiving terminal may further comprise a timer unit (not shown) for determining a time passage in consideration of a time for a user to put waste in the waste receiving device.

Further, when the display unit is provided in the RF receiving terminal, preferably, it may be installed at the front side of the housing 20 so that the information is visually easily provided to the user. However, the present invention is not limited to the position of the display unit.

Referring to FIG. 3, the other end of the cylinder arm 267 fixedly connected to one end of the damper shaft 262 is connected to the first air cylinder 261. When the first air cylinder 261 reciprocates in a straight line, the cylinder arm 267 pivots right and left, around the central axis of the damper shaft 262, so that the damper shaft 262 fixedly connected to the cylinder arm 267 pivots to control the opening/closing of the damper 24.

A cylinder bracket 268 is fixedly connected to the external side of the under passage casing 22 by a bolt. The first air cylinder 261 is connected to the cylinder bracket 268. Since the first air cylinder 261 is capable of slightly pivoting around the axis of the cylinder bracket 268, the cylinder arm 267 connected to the first air cylinder 261 is able to freely pivot right and left around the central axis of the damper shaft 262.

The damper 24 in a hinge type, which is installed under the inlet passage casing 21, i.e., on the under passage casing 22, so as to be opened/closed, is operatively connected to the cover 10 installed on the inlet passage casing 21 so as to be opened/closed by the function of the interlocker 26 ensuring that either the opening or the closing of the damper 24 is opposite to either the opening or closing of the cover 10. That is, when the cover 10 installed on the inlet passage casing 21 is opened, the damper 24 installed under the inlet passage casing 21 is closed, and when the cover 10 installed on the inlet passage casing 21 is closed, the damper 24 installed under the inlet passage casing 21 is opened.

The interlocker 26 operatively connecting the cover 10 and the damper 24 comprises: the first link bar 263; the link tension bar 265; a gas spring 266, the second link bar 264, the damper shaft 262; the cylinder arm 267, the first air cylinder 261 and the cylinder bracket 268.

As illustrated in FIGS. 1 through 4, in the structure where the cover 10 of the capacity-limited waste receiving device is opened, the first link bar 263 controlled by the first air cylinder 261 as the operating unit tightly and tensionally pulls the second link bar 264 fixedly connected to the cover 10 in the single body by the link tension bar 265. In the structure where the cover 10 of the capacity-limited waste receiving device is closed, the length of the link tension bar 265 connecting the first link bar 263 controlled by the first air cylinder 261 as the operating unit to the second link bar 264 fixedly connected to the cover 10 in the single body may vary.

The link tension bar 265 connected to one end of the first link bar 263 and one end of the second link bar 264 includes a slot inside so that the length of the link tension bar 265 can vary. The length of the link tension bar 265 may vary as long as the length of the slot. The gas spring 266 connected to the link tension bar 265 has an absorbing function to a change in the length of the link tension bar 265. When the user opens/closes the cover 10, the user's hand is caught under the cover 10 by his/her carelessness, the gas spring 266 safely stops the cover 10.

The damper 24 is controlled by the first air cylinder 261. When the cover 10 on the inlet passage casing 21 having a capacity-limited space is opened, the damper 24 installed under the inlet passage casing 21 closes the bottom of the inlet passage casing 21 to be closed, thereby preventing oversized waste, a long rod or the like from being received in the under passage casing 22 when the cover 10 is opened.

When the cover 10 installed on the inlet passage casing 21 is closed, the damper 24 installed under the inlet passage casing 21 opens the bottom of the inlet passage casing 21 to be opened, so that the waste temporarily stored in the lower part of the inlet passage casing 21 drops into the under passage casing 22 installed to be connected to the lower end of the inlet passage casing 21 in the inlet passage casing 21 and freely passes through the inside of the under passage casing 22 from the inside of the inlet passage casing 21. The waste passing through the inside of the under passage casing 22 is temporarily stored in the chute 23 installed to be connected to the lower end of the under passage casing 22. When the discharge valve 25 installed under the chute 23 is opened, the waste is conveyed to the central waste collecting station through the conveying line 30 connected under the chute 23.

The operation of the discharge valve 25 is controlled by the second air cylinder 269. The waste conveying line 30 and the compressed air pipe 31 are connected to the central collecting station of the waste collection system (system for conveying the waste through a line).

The end of the damper 24 is rounded in a U shape, so that the waste can be smoothly discharged without being stuck in the damper 24 when the damper 24 is opened to discharge the waste into the under passage casing 22.

The cover 10 and the damper 24 are operatively connected by the interlocker 26 so that the opening/closing of the cover 10 and damper 24 are controlled. When the user opens the cover 10 to put waste in the waste receiving device, the round bar 101 fixedly connected to the cover 10 in the single body rotates clockwise and the second link bar 264 with its one end fixedly connected to the round bar 101 also rotates clockwise, together with the round bar 101. Then, the link tension bar 265 connected to the other end of the second link bar 264 moves down and the cover 10 is opened.

When the first link bar 263 connected to the lower end of the link tension bar 265 rotates clockwise, the damper shaft 262 fixedly connected to one end of the first link bar 263 in the single body also rotates clockwise, so that the damper 24 fixedly connected to the damper shaft 262 in the single body is closed.

Further, when the damper 24 is closed, the cylinder arm 267 with its one end fixedly connected to the damper shaft 262 rotates clockwise around the damper shaft 262 and the first air cylinder 261 connected to the other end of the cylinder arm 267 reciprocates in a straight line.

When the cover 10 is closed after the waste is put in the waste receiving device, the operation is performed in the opposite manner. Either the opening or the closing of the cover 10 is opposite to either the opening or closing of the damper 24 by the operation of the interlocker 26.

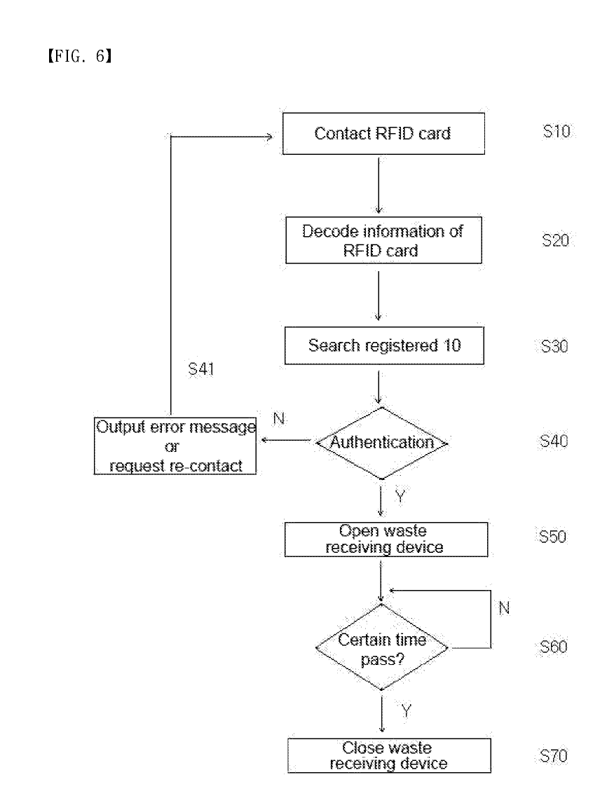

Referring to FIG. 6, an operation method will be described. When a user wants to put waste in the waste receiving device according to the present invention, in step S10 the user brings a registered RFID card into contact with a card reading unit of a RF receiving terminal.

In step S20, the card reading unit of the RF receiving terminal decodes user information from the RFID card being contacted. In step S30, a control unit searches whether the RFID card of the user is registered by using the user information decoded by the RF card reading unit.

The registered user may be stored in a memory built in the RF receiving terminal or it may be registered in a manager system through a wide area network or a local area network. In the case where registration is to be confirmed by the manager system through the wide area network or local area network, it is obvious that a user recognition system 40 further comprises a communication unit.

If the user requesting to open the waste receiving device is registered, in step S50 the control unit of the RF receiving terminal allows an electric current for drive to flow into a solenoid valve 280, to execute a command to open the waste receiving device. Then, the air in a compressed air pipe 31 is supplied to a first air cylinder 261, and a cylinder load of the first air cylinder 261 moves forwardly by the compressed air from the first air cylinder 261, so that a cover 10 is automatically opened/closed.

If it is determined that the user is not registered, in step S41 the control unit outputs a message for re-contact of the RFID card or error through a display, a speaker or the like installed in the RF receiving terminal unit or the like, going back to step S10.

To improve the convenience in use, in step S60 following step S50, the RF receiving terminal determines whether a certain time goes by, using a counter, a timer or the like, when the cover 10 is opened. If it is determined that the predetermined certain time passes, in step S70 the RF receiving unit operates the solenoid valve 280 to drive the first air cylinder 261 backwardly, to close the waste receiving device. Simultaneously, it may be structured to advance inform the user or the like that the waste receiving device will be soon closed, through the output unit such as the display, speaker or the like. Otherwise, it may be structured to recount time by initializing the counter or timer when the RFID card is again brought into contact during the process of counting. Further, instead of using the timer, an infrared sensor or the like may be installed at the front of the housing, thereby controlling the time for opening/closing the waste receiving device.

As described, in the waste receiving device according to the embodiment of the present invention, since the user recognition system 40 is operatively installed at the front of the housing 20, the first air cylinder 261 and the solenoid valve 280 to drive the first air cylinder 261 are installed in the cylinder arm 267 connected to the damper 24, the user may not directly hold the handle to open the cover of the waste receiving device. Accordingly, it is sanitary for the user. Furthermore, it is possible to prevent those that do not have access to the waste collection system from putting waste in the waste receiving device without permission. Accordingly, the waste collection system is very useful when it is installed in the condominium or apartment area, any specific area or the like.

Further, although the RFID card is used in the embodiment of the present invention, a RF transmitter having a RF wireless transmission function and a RF receiver may be used. In this case, the waste receiving device may be structured to be automatically opened when a user having the RF transmitter approaches within a certain distance from the waste receiving device where the RF receiver is installed and to be automatically closed when the user is out of the certain distance from the RF receiver.

The invention has been described using preferred exemplary embodiments. However, it is to be understood that the scope of the invention is not limited to the disclosed embodiments. On the contrary, the scope of the to invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A waste collection system which includes a cover positioned on a waste receiving device so as to be opened/closed, a damper positioned under the waste receiving device so as to be opened/closed through the cover and an interlocker, and a housing, comprising:
a user recognition system operatively installed at the front of the housing; and
an air cylinder operated as a driving unit for driving the opening/closing of the damper, and
wherein the interlocker comprises:
a damper shaft fixedly connected to the damper in a single body;
a first link bar connected to one end of the damper shaft;
a second link bar connected to the cover, for opening/closing the is cover; and
a link tension bar for connecting the first link bar and the second link bar, and
wherein the air cylinder is connected to the other end of the damper shaft and turns on/off the driving unit, based on the results of recognition by the user recognition system.

2. The waste collection system according to claim 1, further comprising: a louver installed on the back side of the housing, to inspect the waste receiving device and air.

3. The waste collection system according to claim 1, wherein the interlocker is structured to close the cover when the damper is opened and to open the cover when the damper is closed.

4. The waste collection system according to claim 3, wherein the housing further comprises:
an inlet passage casing on which the cover is attached; and
an under passage casing installed under the inlet passage casing, wherein the damper is installed between the inlet passage casing and the under passage casing.

5. The waste collection system according to claim 4, wherein the housing further comprises: a chute connected to a lower end of the under passage casing, wherein a discharge valve for discharging waste into a conveying line is positioned under the chute.

6. The waste collection system according to claim 1, wherein the driving unit is connected electrically to the user recognition system through a solenoid valve.

7. The waste collection system according to claim 1, wherein the link tension bar includes a slot formed inside, for making it possible to change a length of the link tension bar.

8. The waste collection system according to claim 7, wherein the link tension bar further includes a gas spring for performing an absorbing function to a change in the length of the link tension bar.
